(19) United States
(12) Patent Application Publication
(10) Pub. No.: US 2025/0157347 A1
(43) Pub. Date: May 15, 2025

(54) AUTOMATED AIR TRAFFIC CONTROL RISK MANAGEMENT SYSTEM

(71) Applicant: Skyway Technologies Corp., San Rafael, CA (US)

(72) Inventors: Clifford FERNANDEZ, New York, NY (US); Derrick Harry LEWIS, New York, NY (US)

(21) Appl. No.: 18/948,332

(22) Filed: Nov. 14, 2024

Related U.S. Application Data
(60) Provisional application No. 63/598,784, filed on Nov. 14, 2023.
(60) Provisional application No. 63/598,791, filed on Nov. 14, 2023.

(51) Int. Cl. G08G 5/00; G05D 1/693; G05D 109/25

(52) U.S. Cl. CPC G08G 5/56; G05D 1/693; G08G 5/26; G05D 2109/254

(57) ABSTRACT

Systems and methods for managing a group of unmanned aerial vehicles (UAVs), such as drones, vertical takeoff and landing (VTOL) aircraft (e.g., electric VTOLs, or eVTOLs), and so on, are described. The systems and methods may provide a navigation system that utilizes artificial intelligence/machine learning (AI/ML) techniques to identify risks associated with the navigation or flight of the UAVs. The navigation system may be associated with navigation pods that monitor UAV traffic for a geographical location and generate recommendations for corrective or mitigation actions. The pods may include multiple user interfaces (UIs) that display various views of the UAV traffic, including views that track the UAVs, views that display the recommendations, views that present alerts or other warnings, and so on.

### CROSS REFERENCE TO RELATED APPLICATIONS

This application claims priority to U.S. Provisional Patent Application No. 63/598,784, filed on Nov. 14, 2023, entitled AUTOMATED AIR TRAFFIC CONTROL RISK MANAGEMENT SYSTEM, and U.S. Provisional Patent Application No. 63/598,791, filed on Nov. 14, 2023, entitled NAVIGATION POD FOR AIR TRAFFIC CONTROL, which are hereby incorporated by reference in their entirety.

### BACKGROUND

Drones and other UAVs (Unmanned Aerial Vehicles), such as vertical take-off and landing (VTOL) aircraft, have many different uses, including surveillance, package delivery, remote sensing, exploration and monitoring of locations, construction and surveying applications, and so on. While the control and management of individual drones can be managed, scenarios or operations that utilize many UAVs (e.g., hundreds of UAVs in a location) can introduce complexities and issues relating to the utilization, control, navigation, and/or management of the UAVs, among other drawbacks.

### BRIEF DESCRIPTION OF THE DRAWINGS

FIG. 1 is a diagram illustrating a suitable network environment for providing air traffic control management and risk mitigation for UAVs.

FIG. 2 is a flow diagram illustrating a method for mitigating an unexpected event at a UAV.

FIG. 3 is a flow diagram illustrating a method for managing an unexpected event via a navigation pod.

FIGS. 4A-4C are diagrams illustrating an example navigation pod for use with a navigation system.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

Systems and methods for managing a group of UAVs, such as drones, vertical takeoff and landing (VTOL) aircraft (e.g., electric VTOLs, or eVTOLs), and so on, are described. The systems and methods may provide a navigation system that utilizes artificial intelligence/machine learning (AI/ML) techniques to identify risks associated with the navigation or flight of the UAVs.

For example, the systems and methods may receive status information for multiple UAVs traveling within a geographical location, track navigation paths of the multiple UAVs based on the status information, predict an unexpected event for a selected UAV of the multiple UAVs based on the tracked navigation paths of the multiple UAVs, and perform an action associated with the predicted unexpected event for the selected UAV.

As another example, the systems and methods may receive an indication of an unexpected event for a UAV or multiple UAVs within a geographical location, identify multiple navigation pods available for the unexpected event, and select a navigation pod to handle the unexpected event based on one or more real-time parameters associated with the multiple navigation pods.

In some embodiments, the navigation pods, such as pods or other computing stations, may monitor UAV traffic for a geographical location (e.g., a target area or airspace) and generate recommendations for corrective or mitigation actions. The pods may include multiple user interfaces (UIs) that display various view of the UAV traffic, including views that track the UAVs, views that display the recommendations, views that present alerts or other warnings, and so on.

For example, the navigation pods may be configured to generate, update, or modify multiple UIs based on identified risks. The UIs may present the information via displays, graphics, or other user interface elements, such that human users/operators of the navigation pods can confirm or determine actions to take with respect to a UAV, a fleet of UAVs, or other risks identified within the UAV traffic. Thus, the systems and methods described herein can employ or implement a risk management system for air traffic control that predict potential navigation risks and generates recommended actions to avoid or mitigate the predicted risks, among other benefits.

In the following description, for the purposes of explanation, numerous specific details are set forth in order to provide a thorough understanding of implementations of the present technology. It will be apparent, however, to one skilled in the art that implementations of the present technology can be practiced without some of these specific details. The phrases “in some implementations,” “according to some implementations,” “in the implementations shown,” “in other implementations,” and the like generally mean the particular feature, structure, or characteristic following the phrase is included in at least one implementation of the present technology and can be included in more than one implementation. In addition, such phrases do not necessarily refer to the same implementations or different implementations.

### Examples of the Navigation System

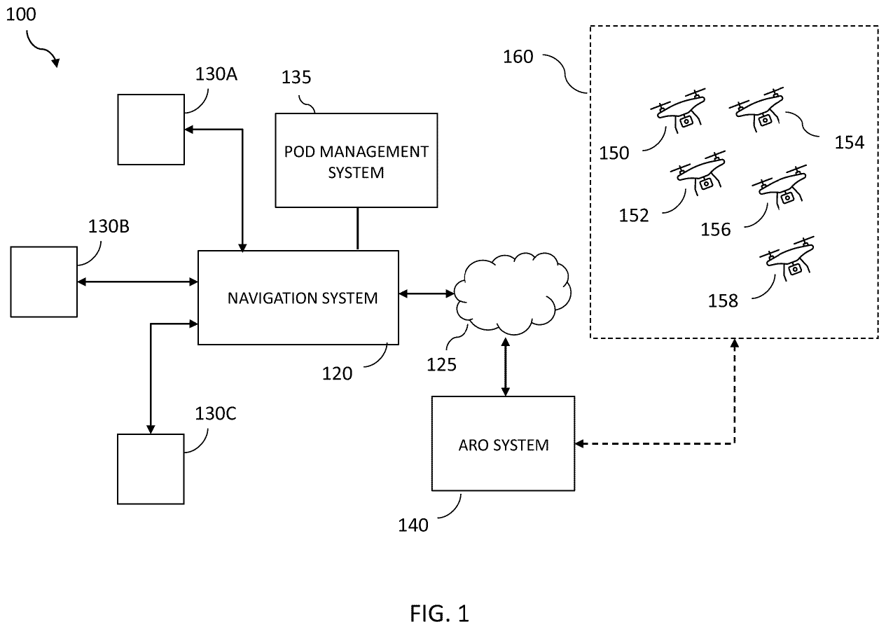

As described herein, the systems and methods provide a navigation system, such as an Al-enabled navigation system, which determines recommendations or actions associated with the navigation of UAVs at a location, airspace, or area. FIG. 1 is a diagram illustrating a suitable network environment 100 for providing air traffic control management and risk mitigation for UAVs.

An air traffic control center 110 includes a navigation system 120, or navigation AI system, and one or more navigation pods 130A-C, which are operated by human operators, such as air traffic controllers, dispatchers, and so on. The navigation system 120 receives or accesses information from an aircraft remote operation (ARO) control or system 140 over a network 125, such as a wireless network.

The ARO system 140 can be a system that operates and/or manages the control of multiple autonomous aircraft 150, 152, 154, 156, 158, such as UAVs or drones, eVTOLs, and so on. The ARO system 140, or ARO, may include or be part of a remotely piloted aircraft system (RPAS), such as a system includes a ground control station (GCS), associated communications systems, and so on.

As described herein, the navigation system 120 ingests or receives information from the ARO system 140, analyzes the information using various Al or ML techniques, and generates information to be presented to human operators at one or more of the navigation pods 130A-C. While three navigation pods are shown in FIG. 1, the navigation system 120 may be associated with fewer (e.g., two) or more pods (e.g., four, six, or more).

The navigation pods 130A-C may be at a same location to one another or could be at locations that are different or remote from one another (and/or the navigation system 120). Further, in some cases, one or some of the navigation pods 130AC may implement some or all aspects of the navigation system 120, and thus may act as a primary navigation pod that interacts with the ARO system 140.

The navigation system 120, in some embodiments, can implement various processes, methods, or techniques when generating recommendations for changes or modifications or current or future navigation of UAVs, such as the autonomous aircraft 150-158.

The aircraft 150-158 (one or more of the UAVs) transmit status information to the ARO system 140 (or to multiple AROs), which may include an autonomy operating system (AOS). The status information can include location or position information, health information, energy or power information, risk factors, and so on. The ARO system 140 sends the information for one or more UAVs to the navigation system 120, such as via APIs provided to the navigation system 120. For example, the navigation system 120 can send a request for information of one UAV or a group of UAVs via an API of the ARO system 140, which responds with the request information.

Using the requested information (e.g., a real-time positioning or location information), Al modules of the navigation system 120 can track the trajectory, navigation paths, or current paths of a UAV or multiple UAVs (e.g., the aircraft 150). During the tracking of the UAVs, the navigation system 120 can identify an unexpected event (e.g., a UAV diverts off an expected or nominal path) and issue a ticket or otherwise sends an alert or message to a selected navigation pod (e.g., pod 130) or a pod management system 135 that manages multiple navigation pods 130.

FIG. 1 and the components depicted herein provide a general computing environment and network within which the system can be implemented. Further, the systems, methods, and techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical discs, compact disc read-only memories (CD-ROMs), magneto-optical disks, ROMs, random access memories (RAMs), erasable programmable read-only memories (EPROMs), electrically erasable e programmable read-only memories (EEPROMs), magnetic or optical cards, flash memory, or other types of media/machine-readable medium suitable for storing electronic instructions.

The network 125 can be any network, ranging from a wired or wireless local area network (LAN) to a wired or wireless wide area network (WAN), to the Internet or some other public or private network. While the connections between the system and other aspects are shown as separate connections, these connections can be any kind of local, wide area, wired, or wireless network, public or private.

Further, any or all components depicted in the Figures described herein can be supported and/or implemented via one or more computing systems or servers. Although not required, aspects of the various components or systems are described in the general context of computer-executable instructions, such as routines executed by a general-purpose computer, e.g., mobile device, a server computer, or personal computer. The system can be practiced with other communications, data processing, or computer system configurations, including Internet appliances, hand-held devices (including tablet computers and/or personal digital assistants (PDAs)), all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Portions of the system may reside on a server computer, while corresponding portions may reside on a client computer such as a mobile or portable device, and thus, while certain hardware platforms are described herein, aspects of the system are equally applicable to nodes on a network. In an alternative embodiment, the mobile device or portable device may represent the server portion, while the server may represent the client portion.

The navigation system 120 may be implemented with a combination of software (e.g., executable instructions, or computer code) and hardware (e.g., at least a memory and processor). Accordingly, as used herein, in some example embodiments, a component or module of the navigation system 120 is a processor-implemented module/component and represents a computing device having a processor that is at least temporarily configured and/or programmed by executable instructions stored in memory to perform one or more of the particular functions that are described herein.

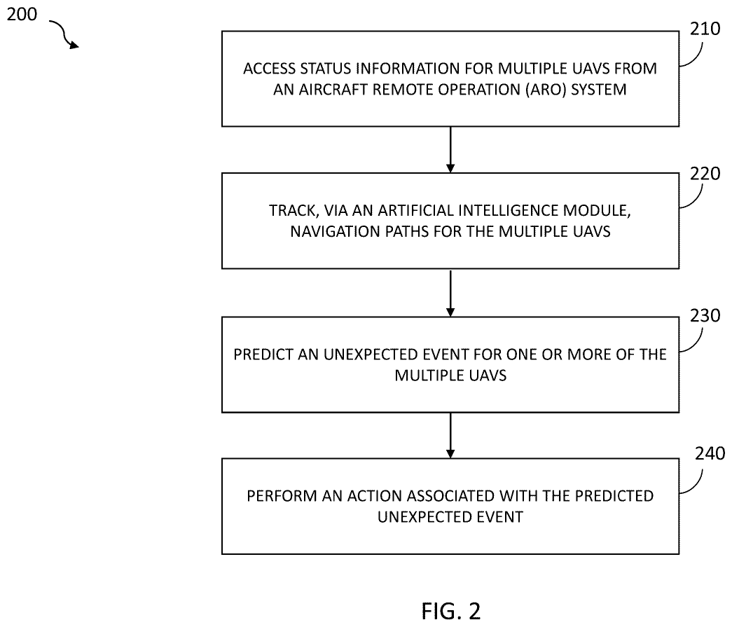

As described herein, the navigation system 120 may perform various actions to mitigate and/or remedy unexpected events associated with UAVs, such as events predicted to occur based on an Al/ML analysis of status information associated with the UAVs. FIG. 2 is a flow diagram illustrating a method 200 for mitigating an unexpected event at a UAV. The method 200 may be performed by the navigation system 120 and, accordingly, is described herein merely by way of reference thereto. It will be appreciated that the method 200 may be performed on any suitable hardware.

In operation 210, the navigation system 120 accesses or receives status information for multiple UAVs from an ARO system. For example, the system 120 may access status information from the ARO system 140 that reflects or represents current paths of travel for the multiple UAVs 150-128 within the geographic area 160 monitored by the ARO system 140. The status information may include location or position information (e.g., GPS information), health information, energy or power information (e.g., battery level information), risk factors, and so on.

In operation 220, the navigation system 120 tracks, via an Al module, navigation paths for the multiple UAVs. The system 120 may utilize various AL and/or ML techniques to generate, recreate, simulate, or otherwise predict current/future paths of travel for some or all of the aircraft 150-158 based on the accessed status information. For example, the system 120 may analyze the status information using an Al/ML technique and generate predicted paths of travel for the multiple UAVs within a geographical location.

In operation 230, the navigation system 120 predicts or otherwise determines an unexpected event for one or more of the multiple UAVs. For example, the system 120 determines a likely occurrence of an unexpected event for a UAV (e.g., a selected, specific, or distinguished UAV) of the aircraft 150-158 based on predicted paths of travel of the UAV (and other UAVs of the aircraft 150-158). An unexpected event may include a collision, a “near miss” where the UAV moves within a threshold distance of another UAV or a geographical object (e.g., two UAVs moving within a certain distance of one another or a UAV traveling proximate to an object, such as a building, tower, tree, and so on), an abnormal course or path of travel, and so on.

In operation 240, the navigation system 120 performs an action associated with the predicted unexpected event. For example, the system 120 may select a navigation pod (e.g., one of the navigation pods 130A-C) to manage the predicted unexpected event. The system 120, via a selected navigation pod, may generate and present an alert and/or otherwise perform a mitigation control operation based on the event. Further details regarding mitigation operations are described herein.

The pod management system 135, which can be part of the navigation system 120 and/or may be a separate module or system, manages the selection of a navigation pod. For example, the selection of a pod may be based on various parameters or factors, include an online status of a pod, an availability or predicted availability of a pod, a safety status of a pod, and so on. Thus, the pod management system 135, in some cases, determines an optimal or suitable pod to select and handle a determination of an unexpected event at a UAV or group of UAVs.

The pod management system 135 may be implemented with a combination of software (e.g., executable instructions, or computer code) and hardware (e.g., at least a memory and processor). Accordingly, as used herein, in some example embodiments, a component or module of the pod management system 135 is a processor-implemented module/component and represents a computing device having a processor that is at least temporarily configured and/or programmed by executable instructions stored in memory to perform one or more of the particular functions that are described herein.

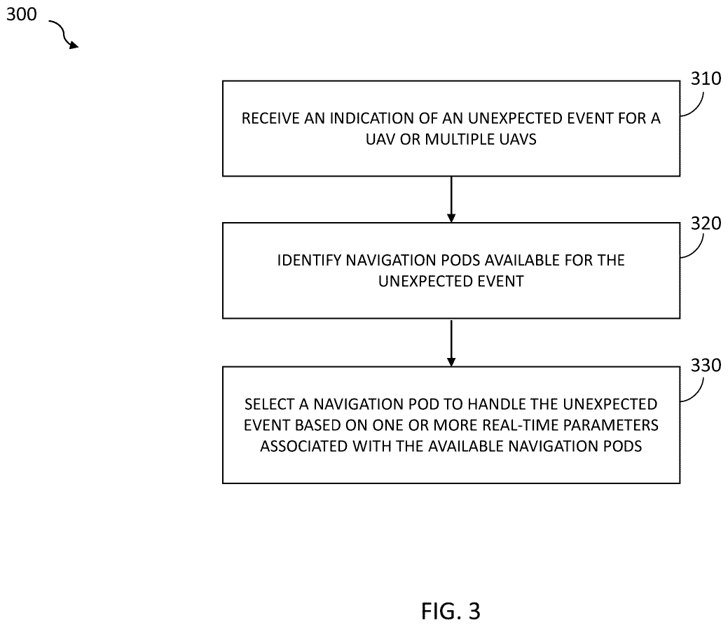

FIG. 3 is a flow diagram illustrating a method 300 for managing an unexpected event via a navigation pod. The method 300 may be performed by the pod management system 135 and, accordingly, is described herein merely by way of reference thereto. It will be appreciated that the method 300 may be performed on any suitable hardware.

In operation 310, the pod management system 135 receives an indication of an unexpected event for a UAV or multiple UAVs. For example, as described herein, the navigation system 120 determines a likely occurrence of an unexpected event for a UAV of the aircraft 150-158 based on predicted paths of travel of the UAV (and other UAVs of the aircraft 150-158).

In operation 320, the pod management system 135 identifies navigation pods available for the unexpected event. The system 135 may access information associated with current operations of the navigation pods 130A-C and determine which pods are available (and/or their operators) to handle or respond to the unexpected event. For example, the information may indicate a current or future availability of a navigation pod (e.g., the pod is currently handling an event and soon to go offline), a priority assigned to a currently handled event (e.g., a pod is currently handling a low priority event or performing a non-navigation task), and so on.

In operation 330, the pod management system 135 selects a navigation pod to handle the unexpected event based on one or more real-time parameters associated with the available navigation pods. Example real-time parameters or metrics may include:
parameters that represent response times and/or resolution durations for the navigation pods (and/or their operators), where the parameters are determined by biometric data (images, heart rate, and so on) associated with the operators;
parameters that represent a current effectiveness for the navigation pods (and/or their operators), where the parameters are determined by recent data (e.g., number of resolutions, speed of resolutions, relative speed or resolutions, speed of control of the navigation pod, and so on) associated with the operators;
parameters that represent a quality of service (QOS) for the navigation pods (e.g., network speeds, type of equipment, operator experience, operator freshness (e.g., has just taken a break or is about to take a break, and so on); and so on.

Thus, the pod management system 135 may identify and/or select a navigation pod that is ideal or suitable for an unexpected event based on matching the parameters associated with the navigation pod with characteristics of the unexpected event.

As describe herein, the navigation pod 130A, 130B, or 130C, via input from a human operation, determines a recommendation, action, or decision associated with the event. For example, the human operator, upon review of information presented by the navigation pod 130, may select a mitigation or modification action, which may cause an adjustment to a current flight path of a UAV. The pod 130 transmits the decision/recommendation to the navigation system 120, which sends updated instructions to the ARO system 140. The ARO system 140 may then operate the aircraft 150 based on the updated instructions (and may send confirmation back to the navigation system 120).

Thus, the navigation system 120, in various embodiments, can act as an interface between an ARO or other control system for UAVs and various human operators of air traffic control systems. The navigation system 120, using AI/ML, may identify unexpected or non-nominal events or actions associated with UAVs, and generate alerts or tickets to mitigate possible risks for the UAVs. The system 120 may also employ various processes for selection suitable navigation pods for determining what actions to perform for the UAVs and facilitate the transfer of instructions between the pods and an aircraft controller, such as the ARO system 140.

### Examples of a Navigation Pod

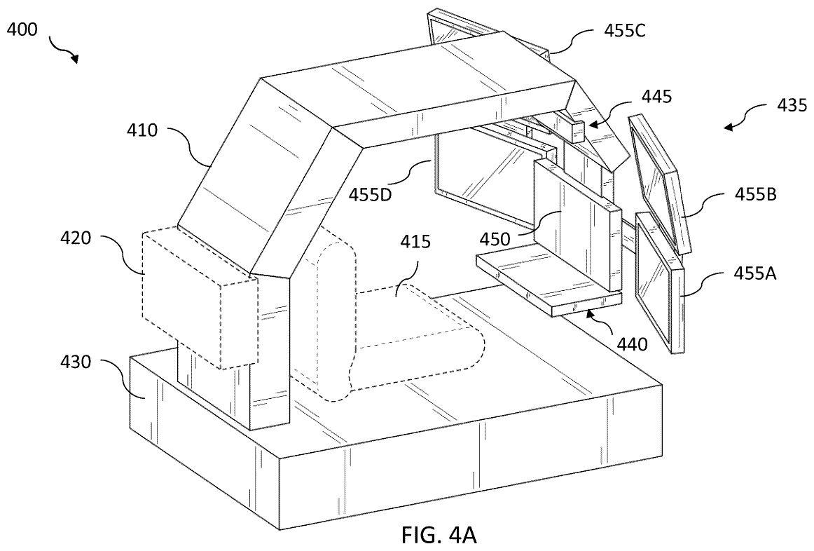

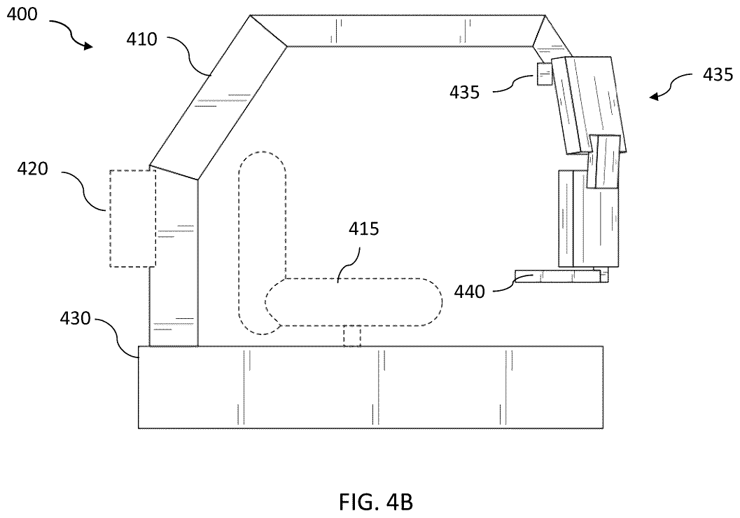

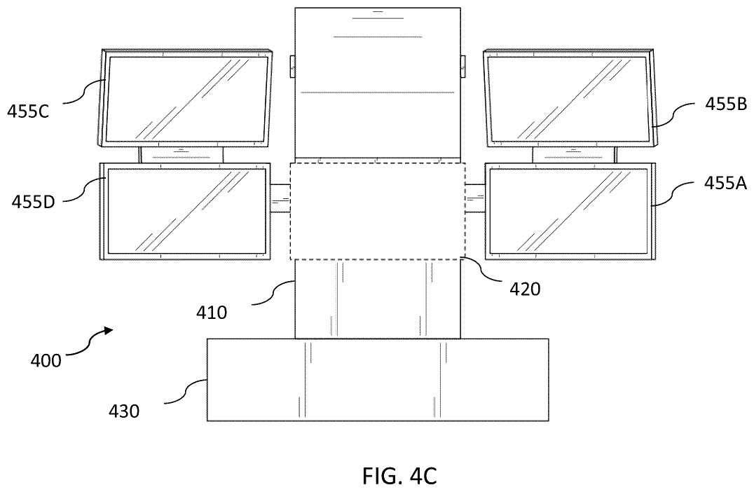

In some embodiments, the navigation system 120 controls the selection of a navigation pod, such as one or more of the navigation pods 130A-C. FIGS. 4A-4C is a diagram illustrating an example navigation pod 400 (e.g., one of the navigation pods 130A-C) for use with the navigation system 120.

The navigation pod 400 includes a metal frame 410 that contains, or partially contains a human operator (not shown), such as an operator seated on a chair 415. The frame 410 can include processing, computing, and/or communication components 420 (e.g., a GPU, network components, cellular components, satellite components, and so on), and power components 430 (e.g., batteries, a battery management system (BMS), and so on). The frame may have a geometry or shape that encloses a rear area and top area of the navigation pod, such as a hook-like or arm-like configuration or geometry.

In some cases, the components 420 include a game engine, which supports and renders the graphics, images, and operations performed by the navigation pod. For example, the game engine may generate a virtual environment that simulates predicted movement of the UAVs for a geographical location and cause the multiple displays to present multiple views of the virtual environment. The views may include information associated with a specific event for the UAVs traveling within a geographical location (e.g., a location monitored by the operator of the navigation pod 400 and/or information associated with the UAVs and the geographical location.

Further, the navigation pod 400 includes various interface components, including multiple screens 435 or displays that present information to the human operators (e.g., a main screen 450 and four auxiliary screens 455A-D) input elements 440 (e.g., keyboards, touch screens, and so on), and information capture components 445 (e.g., cameras, facial recognition components, body detection components, motion detection components), as well as other devices (e.g., speakers, sensors, lighting, and so on).

As described herein, the information capture components 445 can include sensors and/or cameras (e.g., computer vision modules) that track and/o capture biometric and other data for the operation. The information capture components 445 may capture information that is associated with a wakefulness of an operator, a responsiveness of an operator, reaction times for the operator, and so on.

Thus, the navigation pod 400, in various embodiments, includes a frame or structure and various components that facilitate the review of information, in real-time, regarding air traffic control, and the input of decisions or instructions by a human operator to the navigation system 120. For example, the four displays 335 may present information in a certain sequence, arrangement, or order, which can assist or enhance a human operator digesting the information and making decisions to mitigate risk associated with flying UAVs.

In an example scenario, the four displays 335 may display (1) a map of a location (e.g., an overhead view of a map, showing objects of an area (e.g., roads, rivers, land, buildings, trees, and so on) and UAVs traveling through the location, (2), a specific UAV traveling within the location along with flight path or other flight information for the UAV, (3) event information associated with an unexpected event (e.g., time to the event, alert or warning levels or graphics, and so on), and (4) event control information specific to control of the UAV or the event (e.g., a countdown clock or warning screen), among others.

Thus, each of the displays may present information associated with the UAV and/or an unexpected event predicted for the UAV or other UAVs, where the displays are arranged or configured to present the information to the human operator in a configuration that assists the operator to perform mitigation or other control operations.

In some cases, the navigation pod 400, can operate in an autonomous and self-powered manner. The frame 410 includes power components and communication components, and thus the pod 400 can be deployed in remote locations or on temporary assignments, without relying on an established infrastructure to be deployed, among other benefits.

Thus, in some embodiments, the navigation pod may include a frame configured to partially enclose an operator, multiple displays positioned at a front area of the frame, and a computing system positioned at a rear area of the frame.

In some cases, the computing system includes a game engine that generates a virtual environment that simulates predicted movement of unmanned aerial vehicles (UAVs) for a geographical location and causes the multiple displays to present multiple views of the virtual environment.

In some cases, the navigation pod includes an information capture component that captures data associated with operation of the navigation pod by an operator. The information capture component may comprise a CV camera that captures movement information associated with an operator of the navigation pod, or other sensors.

In some cases, the multiple displays include a center display configured to present information associated with a specific event for unmanned aerial vehicles (UAVs) traveling within a geographical location and monitored by an operator of the navigation pod, and multiple auxiliary displays configured to present information associated with the UAVs and the geographical location.

In some cases, the navigation pod includes a battery pack and communication component at least partially contained by the frame.

In some cases, the frame has a geometry that encloses a rear area and top area of the navigation pod.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of implementations of the system is not intended to be exhaustive or to limit the system to the precise form disclosed above. While specific implementations of, and examples for, the system are described above for illustrative purposes, various equivalent modifications are possible within the scope of the system, as those skilled in the relevant art will recognize. For example, some network elements are described herein as performing certain functions. Those functions could be performed by other elements in the same or differing networks, which could reduce the number of network elements. Alternatively, or additionally, network elements performing those functions could be replaced by two or more elements to perform portions of those functions. In addition, while processes, message/data flows, or blocks are presented in a given order, alternative implementations may perform routines having blocks, or employ systems having blocks, in a different order; and some processes or blocks may be deleted, moved, added, subdivided, combined, and/or modified to provide alternative or subcombinations. Each of these processes, message/data flows, or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the methods and system provided herein can be applied to other systems, not necessarily the system described above. The elements, blocks and acts of the various implementations described above can be combined to provide further implementations.

Any patents, applications and other references noted above, including any that may be listed in accompanying filing papers, are incorporated herein by reference. Aspects of the technology can be modified, if necessary, to employ the systems, functions, and concepts of the various references described above to provide yet further implementations of the technology.

These and other changes can be made to the invention in light of the above Detailed Description. While the above description describes certain implementations of the technology, and describes the best mode contemplated, no matter how detailed the above appears in text, the invention can be practiced in many ways. Details of the system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific implementations disclosed in the specification, unless the above Detailed Description section explicitly defines such terms. Accordingly, the actual scope of the invention encompasses not only the disclosed implementations, but also all equivalent ways of practicing or implementing the invention under the claims.

We claim:

1. A navigation pod, comprising:
a frame configured to partially enclose an operator;
multiple displays positioned at a front area of the frame; and
a computing system positioned at a rear area of the frame.

2. The navigation pod of claim 1, wherein the computing system includes a game engine that:
generates a virtual environment that simulates predicted movement of unmanned aerial vehicles (UAVs) for a geographical location; and
causes the multiple displays to present multiple views of the virtual environment.

3. The navigation pod of claim 1, further comprising:
an information capture component that captures data associated with operation of the navigation pod by an operator.

4. The navigation pod of claim 3, wherein the information capture component comprises a computer vision (CV) camera that captures movement information associated with an operator of the navigation pod.

5. The navigation pod of claim 1, wherein the multiple displays comprise:
a center display configured to present information associated with a specific event for unmanned aerial vehicles (UAVs) traveling within a geographical location and monitored by an operator of the navigation pod; and
multiple auxiliary displays configured to present information associated with the UAVs and the geographical location.

6. The navigation pod of claim 1, further comprising:
a battery pack and communication component at least partially contained by the frame.

7. The navigation pod of claim 1, where the frame has a geometry that encloses a rear area and top area of the navigation pod.

8. A method, comprising:
receiving status information, from an aircraft remote operation (ARO), for multiple unmanned aerial vehicles (UAVs) traveling within a geographical location;
tracking navigation paths of the multiple UAVs based on the status information;
predicting an unexpected event for a selected UAV of the multiple UAVs based on the tracked navigation paths of the multiple UAVs, and
performing an action associated with the predicted unexpected event for the selected UAV.

9. The method of claim 8, wherein tracking the navigation paths of the multiple UAVs based on the status information includes:
analyzing the status information using an artificial intelligence (AI) techniques; and
generating predicted paths of travel for the multiple UAVs within the geographical location.

10. The method of claim 8, wherein the status information includes position information for the multiple UAVs within the geographical location and power information for the multiple UAVs.

11. The method of claim 8, wherein predicting an unexpected event for a selected UAV includes determining a likely occurrence of the unexpected event based on tracked navigation paths of the multiple UAVs.

12. The method of claim 8, wherein the unexpected event is a collision between the selected UAV and one or more of the multiple UAVs within the geographical location.

13. The method of claim 8, wherein the unexpected event is a position of the selected UAV being within a threshold minimum distance to positions of one or more of the multiple UAVs within the geographical location.

14. The method of claim 8, wherein the unexpected event is a position of the selected UAV being within a threshold minimum distance to a position of a geographical object within the geographical location.

15. The method of claim 8, wherein the unexpected event is an abnormal path of travel by the selected UAV within the geographical location.

16. The method of claim 8, wherein performing an action associated with the predicted unexpected event for the selected UAV includes generating and presenting an alert associated with the unexpected event.

17. The method of claim 8, wherein performing an action associated with the predicted unexpected event for the selected UAV includes selecting a navigation pod to support a mitigation control operation for the selected UAV.

18. A non-transitory computer-readable medium whose contents, when executed by a computing system, cause the computing system to perform a method, the method comprising:
receive an indication of an unexpected event for an unmanned aerial vehicle (UAV) or multiple UAVs within a geographical location;
identify multiple navigation pods available for the unexpected event; and
select a navigation pod to handle the unexpected event based on one or more real-time parameters associated with the multiple navigation pods.

19. The non-transitory computer-readable medium of claim 18, wherein identifying multiple navigation pods available for the unexpected event includes identifying a navigation pod is available based on:
information associated with a current or future availability of a navigation pod; and
information associated with a priority assigned to an event currently being handled by the navigation pod.

20. The non-transitory computer-readable medium of claim 18, wherein the selection of the navigation pod to handle the unexpected event is based on:
one or more parameters that represent a response time of the navigation pod or an operator of the navigation pod;
one or more parameters that represent an effectiveness of the navigation pod or an operator of the navigation pod; and
one or more parameters that represent a quality of service (QOS) of the navigation pod or an operator of the navigation pod.
